(19) United States
(12) Patent Application Publication
(10) Pub. No.: US 2016/0225534 A1
(43) Pub. Date: Aug. 4, 2016

(54) COMPOSITE DYE-SENSITIZED SOLAR CELL

(71) Applicant: NATIONAL YUNLIN UNIVERSITY OF SCIENCE AND TECHNOLOGY, Yunlin County (TW)

(72) Inventors: Jian-Yang LIN, Yunlin County (TW); Chih-Kai HU, Yunlin County (TW); Jyun-Hao JHANG, Yunlin County (TW); Guan-Ting LIOU, Yunlin County (TW)

(21) Appl. No.: 15/095,692

(22) Filed: Apr. 11, 2016

Related U.S. Application Data
(63) Continuation-in-part of application No. 13/965,866, filed on Aug. 13, 2013.
Application No. 13/965,866 is a continuation-in-part of application No. 12/970,465, filed on Dec. 16, 2010, now abandoned.

(51) Int. Cl. H01G 9/20

(52) U.S. Cl. CPC H01G 9/2031; H01G 9/2004

(57) ABSTRACT

A composite dye-sensitized solar cell comprises a conductive substrate, and also a nanoparticle compact layer, a nanotube layer and a nanoparticle scattering layer which are stacked on the conductive substrate sequentially, and further an auxiliary electrode stacked on one side of the nanoparticle scattering layer far away from the conductive substrate, and a composite dye and an electrolyte filled into a space between the conductive substrate and the auxiliary electrode. The composite dye includes at least one short-wavelength light absorption dye and at least one long-wavelength light absorption dye. The nanoparticle compact layer can increase the contact area with the composite dye and further enhance the power generation efficiency. The nanotube layer can transmit the generated electric energy to the external electrodes efficiently. The composite dye can absorb light with different wavelength ranges. Therefore is effectively improved the photovoltaic conversion efficiency of the dye-sensitized solar cell (DSSC).

This is a continuation-in-part, and claims priority, from U.S. patent application Ser. No. 13/965,866 filed on Aug. 13, 2013, entitled “COMPOSITE DYE-SENSITIZED SOLAR CELL” which is a continuation-in-part of U.S. patent application Ser. No. 12/970,465 filed on Dec. 16, 2010, entitled “DYE-SENSITIZED SOLAR CELL WITH HYBRID NANOSTRUCTURES AND METHOD FOR FABRICATING WORKING ELECTRODES THEREOF”, the entire contents of which are hereby incorporated by reference.

### FIELD OF THE INVENTION

The present invention relates to a solar cell, particularly to a composite dye-sensitized solar cell.

### BACKGROUND OF THE INVENTION

In DSSC (Dye-Sensitized Solar Cell), dye molecules are chemically absorbed by metal oxide semiconductor nanoparticles; then, the nanoparticles are spread on the cathode to function as a photosensitive layer; an electrolyte is interposed between the photosensitive layer and the anode to assist in electric conduction. DSSC has the following advantages:
1. The photosensitive particles have an effective light absorption area 100 times greater than the surface area of the electrode. Therefore, DSSC has very high light absorption efficiency, using a very small amount of material.
2. The photosensitive particles are fabricated via merely soaking the semiconductor particles in a dye solution and drying the particles with an inert gas. Therefore, DSSC has a simple and inexpensive fabrication process.
3. The dye of DSSC has a wide absorption spectrum in the range of visible light. Therefore, a single type of DSSC elements can harness a wide spectrum of solar light.
4. DSSC is semitransparent and suitable to be a construction material, especially a window material. For example, DSSC may be used as glass curtain walls of high-rise buildings to provide functions of sunlight sheltering, thermal insulation and power generation. Therefore, a building may have efficacies of power saving and power generation via using DSSC.

Generally, a solar cell is expected to have low cost, low fabrication complexity, and high photovoltaic conversion efficiency. DSSC indeed has the characteristics of low cost and low fabrication complexity. However, the photovoltaic conversion efficiency thereof still needs improving. A TW publication No. 201001724 disclosed a “Dye Sensitized Solar Cell Having a Double-Layer Nanotube Structure and Manufacture Method Thereof”. The nanotube structures can increase the electric conduction efficiency of DSSC. However, nanotubes have less area to absorb dye than nanoparticles. Thus is decreased the photovoltaic conversion efficiency of the prior-art DSSC.

### SUMMARY OF THE INVENTION

The primary objective of the present invention is to promote the photovoltaic conversion efficiency of a dye-sensitized solar cell.

To achieve the abovementioned objective, the present invention proposes a composite dye-sensitized solar cell, which comprises a conductive substrate, and also a nanoparticle compact layer, a nanotube layer and a nanoparticle scattering layer which are stacked on the conductive substrate in sequence, and further an auxiliary electrode stacked on one side of the nanoparticle scattering layer far away from the conductive substrate, and a composite dye and an electrolyte filled into a space between the conductive substrate and the auxiliary electrode. The nanoparticle compact layer includes a plurality of fine titanium dioxide nanoparticles. The nanoparticle scattering layer includes a plurality of coarse titanium dioxide nanoparticles. The nanotube layer includes a plurality of titanium dioxide nanotubes, and each nanotube includes two openings respectively at two ends thereof. The composite dye includes at least one short-wavelength light absorption dye and at least one long-wavelength light absorption dye.

Via the abovementioned technical design, the present invention has the following advantages:
1. The fine nanoparticles of the nanoparticle compact layer can increase the contact area between the metal oxide and the dyes and thus can increase the photovoltaic conversion efficiency of the dye-sensitized solar cell.
2. The nanotubes of the nanotube layer can increase the carrier transmission rate and thus can transmit the generated electric energy to the electrodes efficiently. Each nanotube includes two openings and thus has a greater contact area with the composite dye to promote the photovoltaic conversion efficiency of the dye-sensitized solar cell.
3. The composite dye can absorb light with different wavelength ranges and thus can effectively improve the photovoltaic conversion efficiency of the dye-sensitized solar cell.

### BRIEF DESCRIPTION OF THE DRAWINGS

FIG. 1 schematically shows the structure of the stacked layers of a composite dye-sensitized solar cell according to one embodiment of the present invention;

FIGS. 2A-2D schematically show the steps of fabricating a composite dye-sensitized solar cell according to one embodiment of the present invention;

FIG. 3 shows a flowchart of a method for fabricating a composite dye-sensitized solar cell according to one embodiment of the present invention;

FIG. 4 shows a relationship between the wavelength and the light absorption of a composite dye according to one embodiment of the present invention.

### DETAILED DESCRIPTION OF THE PREFERRED EMBODIMENTS

The technical contents of the present invention will be described in detail in cooperation with the drawings below.

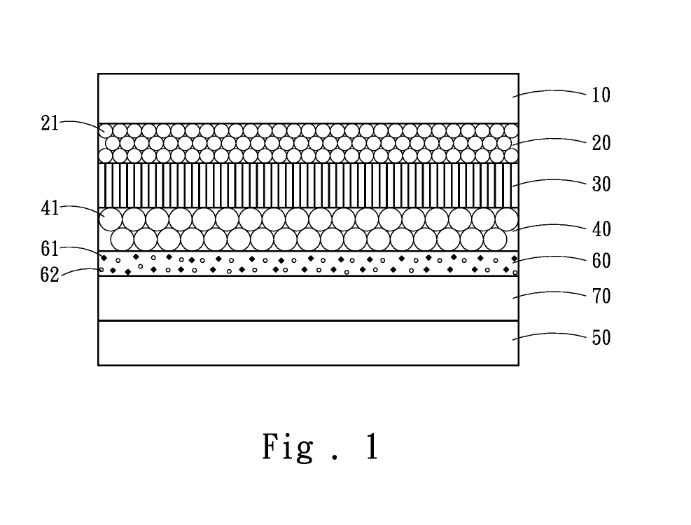

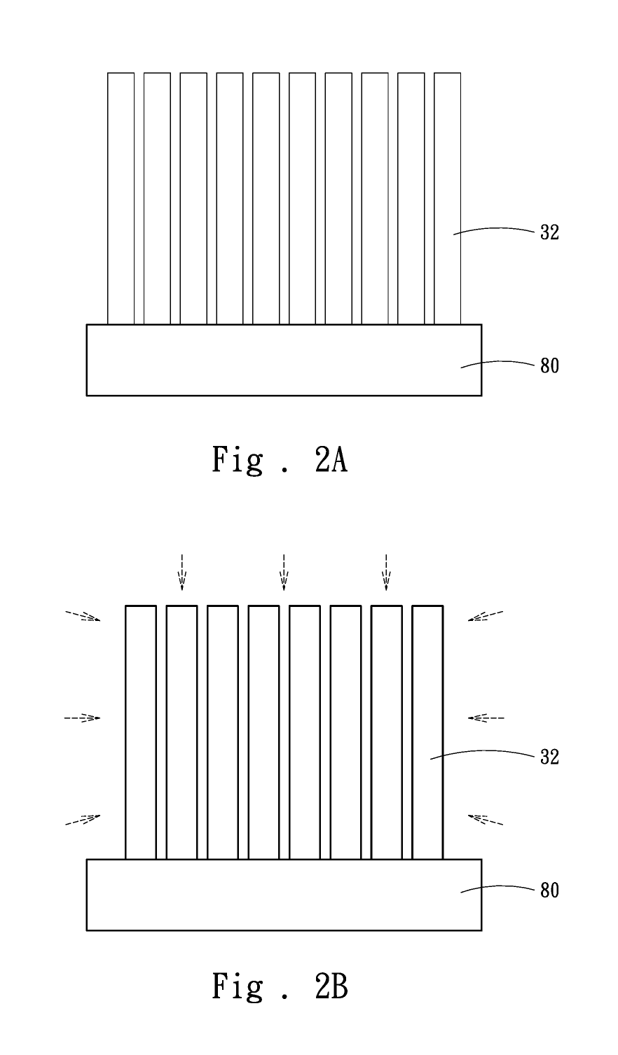

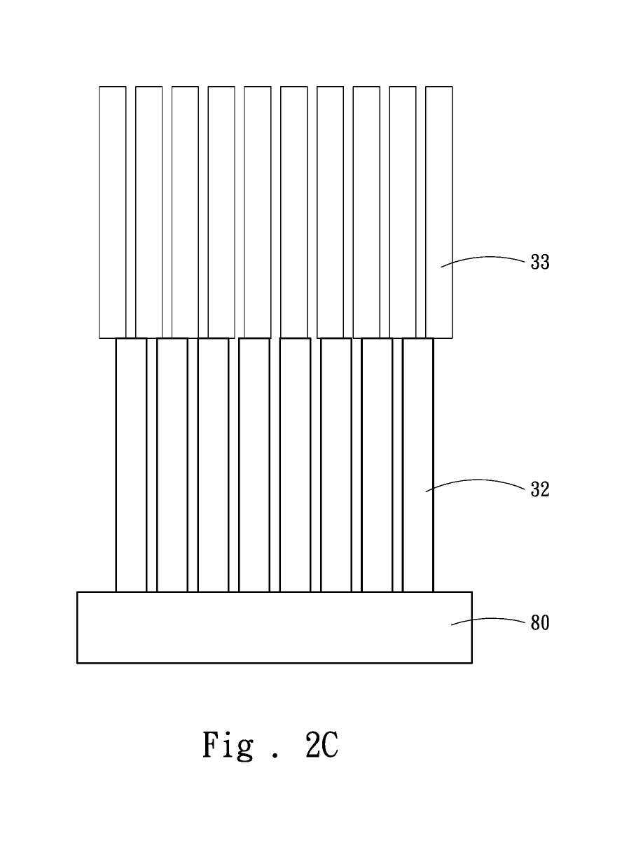

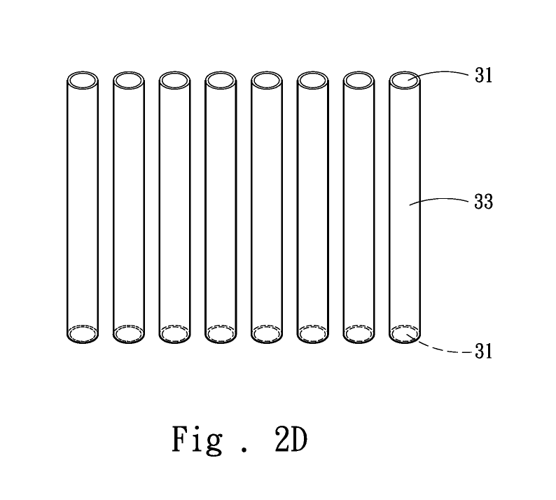

Refer to FIG. 1 schematically shows the structure of the stacked layers of a composite dye-sensitized solar cell according to one embodiment of the present invention. The composite dye-sensitized solar cell of the present invention comprises a conductive substrate 10, and also a nanoparticle compact layer 20, a nanotube layer 30 and a nanoparticle scattering layer 40 which are stacked on the conductive substrate 10 in sequence, and further an auxiliary electrode 50 stacked on one side of the nanoparticle scattering layer 40 far away from the conductive substrate 10, and a composite dye and an electrolyte filled into a space between the conductive substrate 10 and the auxiliary electrode 50. The nanoparticle compact layer 20 includes a plurality of fine titanium dioxide nanoparticles 21, wherein the fine titanium dioxide nanoparticles 21 are formed in a spheroidal shape and have a diameter smaller than 40 nm. The nanoparticle scattering layer 40 includes a plurality of coarse titanium dioxide nanoparticles 41, wherein the coarse titanium dioxide nanoparticles 41 also are formed in a spheroidal shape and have a diameter greater than 70 nm. The nanotube layer 30 includes a plurality of titanium dioxide nanotubes, and each nanotube includes two openings 31 respectively at two ends thereof (as shown in FIG. 2D). The composite dye includes at least one short-wavelength light absorption dye 61 and at least one long-wavelength light absorption dye 62. In one embodiment, the short-wavelength light absorption dye 61 is Ruthenium 535-bisTBA, and the long-wavelength light absorption dye 62 is Green dye, whereby light with different wavelengths is absorbed and the photovoltaic conversion efficiency is increased. In one embodiment, the ratio of the short-wavelength light absorption dye 61 to the long-wavelength light absorption dye 62 is 8:2. The electrolyte may be selected from a group consisting of lithium iodide, iodine, TBP (4-Tert-Butylpyridine), DMPII (1,2-dimethyl-3-propylimidazolium iodide) and combinations thereof. After the composite dye is filled into the space between the conductive substrate 10 and the auxiliary electrode 50, the composite dye contacts the surfaces of the nanoparticle compact layer 20, the nanotube layer 30 and the nanoparticle scattering layer 40. In the embodiment shown in FIG. 1, the composite dye forms a composite dye layer 60 on one side of the nanoparticle scattering layer 40, which is far away from the conductive substrate 10. In the embodiment shown in FIG. 1, the electrolyte form an electrolyte layer 70 on one side of the composite dye layer 60, which is far away from the conductive substrate 10. The process of absorbing light to generate electricity belongs to the basic principle of DSSC and will not repeat herein.

The nanotubes are obtained via an anodic oxidization growth method. Refer to FIGS. 2A-2D. Firstly, as shown in FIG. 2A, use a first anodization process to form a plurality of first nanotubes 32 on a titanium substrate 80. Next, as shown in FIG. 2B, use an annealing process to harden the first nanotubes 32. Next, as shown in FIG. 2C, use a second anodization process to form a plurality of second nanotubes 33 above the first nanotubes 32. Next, as shown in FIG. 2D, soak the titanium substrate 80 and the nanotubes thereon in a hydrogen peroxide solution, and shake off the second nanotubes 33 ultrasonically to form the nanotubes each with two openings 31 at two ends thereof. Meanwhile, the first nanotubes 32 still remain on the titanium substrate 80 because they have higher hardness and higher strength.

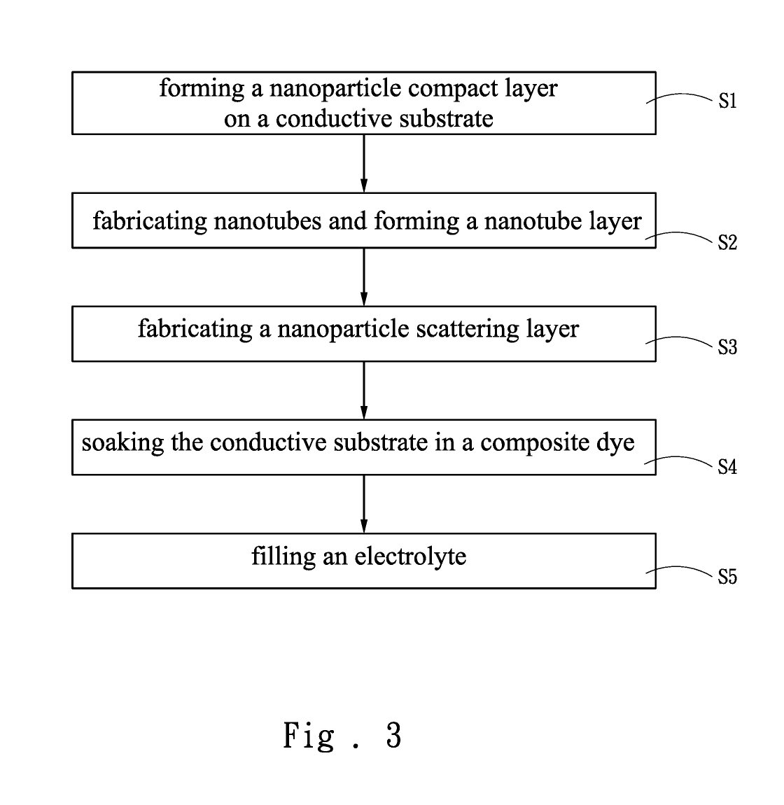

Below is described a method for fabricating a composite dye-sensitized solar cell according to one embodiment of the present invention. Refer to FIG. 1 and FIG. 3. The method of the present invention comprises Steps S1-S5.

Step S1—forming a nanoparticle compact layer 20 on a conductive substrate 10: Mix acetic acid, deionized water, P-90 anatase nanoparticles and acetylacetonate to form a gel, and spin-coat the gel on the conductive substrate 10, and dry the spin-coated gel to remove acetic acid, deionized water and acetylacetonate to form the nanoparticle compact layer 20.

Step S2—fabricating nanotubes and forming a nanotube layer 30: Use the abovementioned method to fabricate a plurality of nanotubes each including two openings 31, and place the nanotubes on the nanoparticle compact layer 20, and dry the nanotubes to form the nanotube layer 30.

Step S3—fabricating a nanoparticle scattering layer 40: Mix acetic acid, deionized water, P-25 anatase nanoparticles and acetylacetonate to form a gel, and spin-coat the gel on the nanotube layer 30, and dry the spin-coated gel to remove acetic acid, deionized water and acetylacetonate to form the nanoparticle scattering layer 40.

Step S4—soaking in a composite dye: Soak one side of the nanoparticle scattering layer 40, which is far away from the conductive substrate 10, in a composite dye to form a composite dye layer 60 on the side of the nanoparticle scattering layer 40, which is far away from the conductive substrate 10.

Step 55—filling an electrolyte: Fill an electrolyte into a space between the conductive substrate 10 and an auxiliary electrode 50 to form an electrolyte layer 70, and undertake package to form a composite dye-sensitized solar cell.

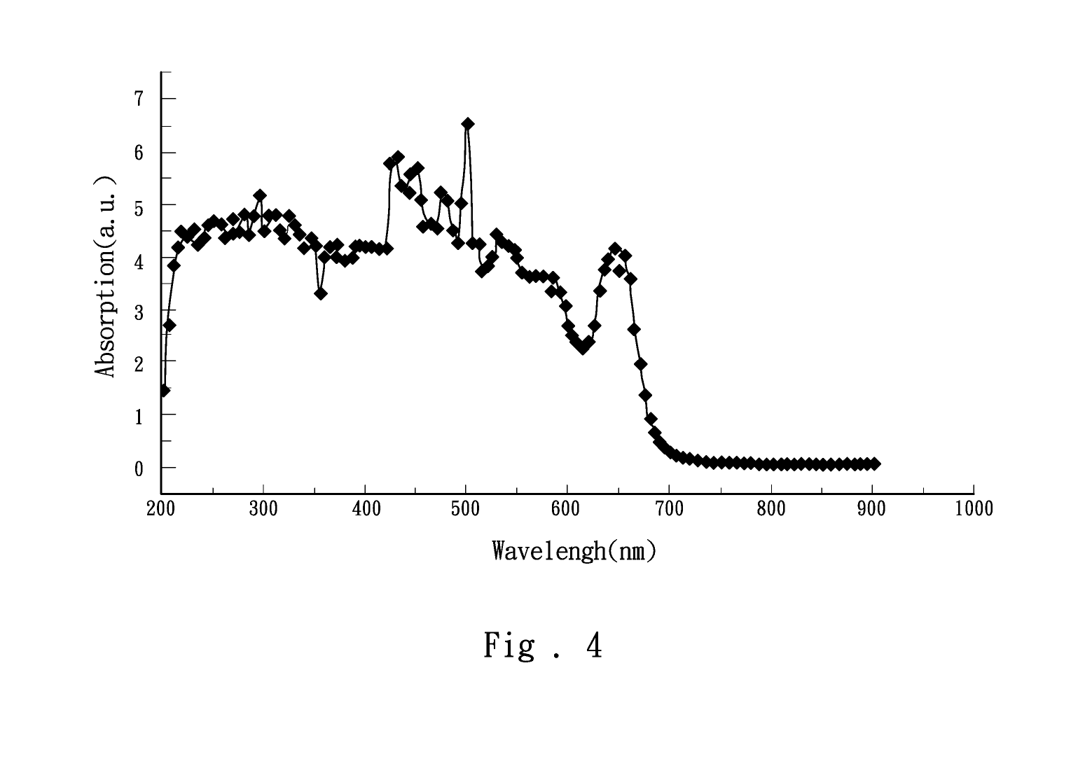

Refer to FIG. 4 for a relationship between the wavelength and the light absorption of a composite dye of a composite dye-sensitized solar cell according to one embodiment of the present invention. It is observed in FIG. 4 that the composite dye of the present invention has pretty high light absorption in the wavelength range of 250-650 nm. In experiments, the dye-sensitized solar cell merely using the short-wavelength light absorption dye 61 (Ruthenium 535-bisTBA) has a photovoltaic conversion efficiency of only 1.2%; the dye-sensitized solar cell merely using the long-wavelength light absorption dye 62 (Green dye) has a photovoltaic conversion efficiency of as low as 0.67%. However, the photovoltaic conversion efficiency of the dye-sensitized solar cell using the composite dye containing Ruthenium 535-bisTBA and Green dye by a ratio of 8:2 is increased to as high as 1.75%. Thus is proved that the present invention can effectively promote the photovoltaic conversion efficiency of the dye-sensitized solar cell.

In conclusion, the present invention is characterized in:
1. The fine nanoparticles of the nanoparticle compact layer can increase the contact area between the metal oxide and the dyes and thus can increase the photovoltaic conversion efficiency of the dye-sensitized solar cell.
2. The nanotubes of the nanotube layer can increase the carrier transmission rate and thus can transmit the generated electric energy to the electrodes efficiently. Each nanotube includes two openings and thus has a greater contact area with the composite dye to promote the photovoltaic conversion efficiency.
3. The coarse nanoparticles of the nanoparticle scattering layer can effectively scatter the incident light and increase the light absorption of the solar cell.
4. The composite dye can absorb light with different wavelength ranges and thus can effectively improve the photovoltaic conversion efficiency of the dye-sensitized solar cell.

What is claimed is:

1. A composite dye-sensitized solar cell, comprising:
a conductive substrate;
a nanoparticle compact layer, a nanotube layer and a nanoparticle scattering layer which are stacked on the conductive substrate in sequence, wherein the nanoparticle compact layer includes a plurality of fine titanium dioxide nanoparticles, and wherein the nanotube layer includes a plurality of titanium dioxide nanotubes each including two openings at two ends thereof, and wherein the nanoparticle scattering layer includes a plurality of coarse titanium dioxide nanoparticles;
an auxiliary electrode stacked on one side of the nanoparticle scattering layer, which is far away from the conductive substrate;
a composite dye and an electrolyte filled into a space between the conductive substrate and the auxiliary electrode, wherein the composite dye includes at least one short-wavelength light absorption dye and at least one long-wavelength light absorption dye, and wherein the composite dye forms a composite dye layer on one side of the nanoparticle scattering layer, which is far away from the conductive substrate.

2. The composite dye-sensitized solar cell according to claim 1, wherein the fine titanium dioxide nanoparticles have a diameter smaller than 40 nm, and the coarse titanium dioxide nanoparticles have a diameter greater than 70 nm.

3. The composite dye-sensitized solar cell according to claim 1, wherein the short-wavelength light absorption dye is Ruthenium 535-bisTBA.

4. The composite dye-sensitized solar cell according to claim 1, wherein the long-wavelength light absorption dye is Green dye.

5. The composite dye-sensitized solar cell according to claim 1, wherein the short-wavelength light absorption dye is Ruthenium 535-bisTBA; the long-wavelength light absorption dye is Green dye; the composite dye includes the Ruthenium 535-bisTBA and the Green dye by a ratio of 8:2.

6. The composite dye-sensitized solar cell according to claim 1, wherein the electrolyte is selected from a group consisting of lithium iodide, iodine, TBP (4-Tert-Butylpyridine), DMPII (1,2-dimethyl-3-propylimidazolium iodide) and combinations thereof.
